(19) United States
(12) Patent Application Publication
(10) Pub. No.: US 2025/0146620 A1
(43) Pub. Date: May 8, 2025

(54) Support System

(71) Applicant: Cory HASS, Dalhart, TX (US)

(72) Inventor: Cory HASS, Dalhart, TX (US)

(21) Appl. No.: 18/225,545

(22) Filed: Jul. 24, 2023

Related U.S. Application Data
(60) Provisional application No. 63/392,673, filed on Jul. 27, 2022.

(51) Int. Cl. F16M 13/04; F41H 5/08

(52) U.S. Cl. CPC F16M 13/04; F41H 5/08

(57) ABSTRACT

A system and method for a support system. The system couples a harness strap to a hanging hook. The hanging hook couples with equipment, such as a ballistics shield. This allows the weight of the shield to be transferred to the harness strap and frees up the hands of the operator.

### PRIORITY

The present invention claims priority to U.S. Provisional App. 63/392,673 filed Jul. 27, 2022, the entirety of which is hereby incorporated by reference.

### TECHNICAL FIELD

The present invention relates to a system and method for a support system.

### DESCRIPTION OF RELATED ART

Law enforcement often uses a ballistics shield. Ballistics shields are protective devices deployed by forces which are designed to stop or deflect bullets or other projectiles. Ballistics shields are used in training and in actual combat and confrontational operations. The ballistics shields are carried by the operator. These shields can get heavy, and after holding them for a period of time, the user can get tired. Consequently, there is a need for a better way to hold the shield.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a top perspective view of a support system in one embodiment;

FIG. 2 is a top perspective view of a support system in one embodiment;

FIG. 3 is a top perspective view of a support system in one embodiment;

FIG. 4 is a top perspective view of a clip in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

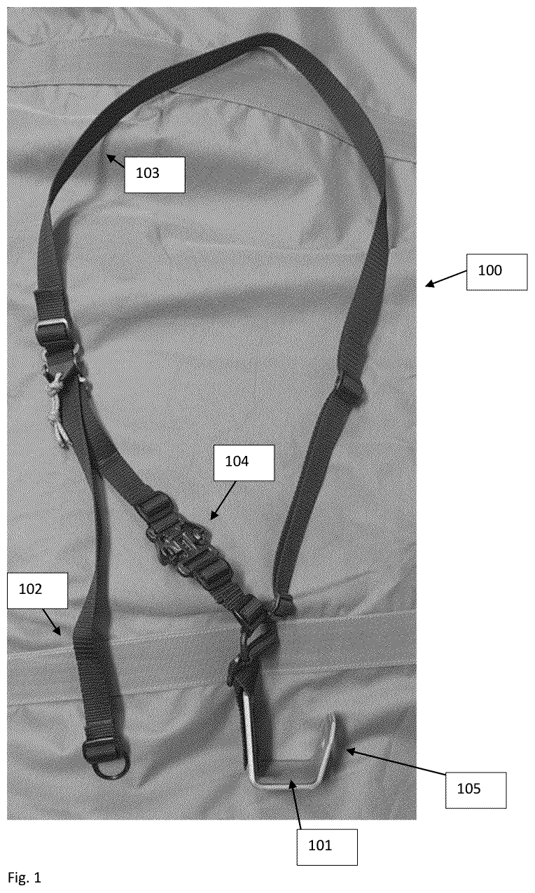

FIG. 1 is a top perspective view of a support system in one embodiment. A support system 100, as used herein, refers to a system which allows equipment to be coupled to, and supported by, a user. In one embodiment discussed herein, the equipment is a ballistics shield. This is for illustrative purposes only and should not be deemed limiting. Other equipment, shields, etc. which can couple to the support system can also be utilized.

In one embodiment the support system 100 comprises a series of interconnected straps. The straps can be connected via any method or device known in the art. The straps can be permanently attached or removeably attached. A strap which is permanently connected is coupled via threading, welding, or the like which couples two or more straps together. Even though sewn straps can be removed by removing the threading, they are still permanent straps because it requires altering the structure to de-couple the straps.

Straps which are removeably attached comprise a device which allows coupling and de-coupling. This can be clips 104 which mechanically couple two or more straps. The clips 104 can be friction fit, mechanical clasps, magnets, etc. Virtually any device which allows for clips 104 to couple and de-couple can be utilized.

FIG. 1 shows an adjusting strap 102 which is coupled via a clip 104 to the harness strap 103. Each of these straps are discussed in more detail below.

The adjusting strap 102 is a strap which allows the length of the harness strap 103 to be lengthened, shortened, etc. If a taller operator is coupling to the support system 100, then the size of the harness strap 103 will likely need to be lengthened to account for the height of the operator. Similarly, if a shorter operator subsequently utilizes the support system 103, the support strap 102 is utilized to shorten the harness strap 103.

The adjusting strap 102 can comprise any strap or device which allows the length of the harness strap 103 to be adjusted. In some embodiments the adjusting strap 102 is coupled to a portion of the harness 103 so that if the adjusting strap 102 is pulled, the harness strap 103 shortens. This is for illustrative purposes only and should not be deemed limiting. Other methods to shorten or lengthen the harness strap 103 can also be utilized.

The harness strap 103 is placed around the operator when in use. The harness strap 103 can wrap around the user's neck, shoulders, etc. The user can determine a comfortable spot to use the harness strap 103. The harness strap 103 can simply slip on a user's neck. Or, in other embodiments, the harness strap 103 can comprise a clip, snap, or equivalent whereby the user disconnects the system and reattaches it in the desired location.

The harness strap 103 couples the support system 100 to the operator. In so doing, rather than the operator separately holding the equipment, such as a ballistics shield, in a hand or two hands, the weight of the ballistics shield is transferred to the support system 100 and to the operator.

For a ballistics shield, previously, the operator would hold the shield with the operator's off-hand. The operator's hands supports the weight of the shield. The other hand holds a firearm, for example. By allowing the weight of the shield to be supported by the support system 100, the operator has one or more hands free to hold, manipulate, and fire the firearm. This is much preferable than juggling both the shield and the firearm. Further, often the training in which these shields are used is lengthy in time. Similarly, the stand-offs or tactical operations when in use can take several hours. Operators are forced to hold this equipment, such as ballistics shields, for length periods of time. The result is the operator is tired or sore when they are perhaps needed at their best. Even if, in some embodiments, the operator's off-hand is still needed to stabilize the shield, that hand is not supporting the weight of the shield.

Coupled to the harness strap 103 is the hanging hook 101. The hanging hook 101, in one embodiment, couples to the equipment such that the weight of the equipment is housed and supported by the support system 100. In one embodiment, the hanging hook 101 attaches to the ballistic shield's handle. This allows for a quick and easy coupling and de-coupling of the hanging hook 101 to the shield.

As shown the hanging hook 101 comprises an open end whereby a handle, edge, or other feature can be received by the open end of the hook 101. In the embodiment depicted the hook 101 comprises a lip 105 which engages with the equipment, such as a shield. In such embodiments the equipment can be simply placed into the open hook and removed as needed. The lip 105 will engage with the equipment and secure it in place. In some embodiments this is advantage in that it allows the operator to quickly disengage with the support system 100 if necessary. If the user must quickly disengage to move, make an adjustment, etc., the operator can quickly do so. The size of the lip 105 can vary depending upon the shield. In one embodiment the lip 105 is about 1.5-2 inches in height.

In one embodiment the hanging hook 101 comprises a planar and contiguous base (the portion of the hanging hook upon which a shield will rest) and a planar and contiguous lip 105. As can be seen, the lip 105 extends outward away from the planar face of the base. Contiguous, as used herein, refers to a planar continuous piece. Thus, a folded sheet of metal constitutes a contiguous piece.

In other embodiments, the hanging hook 101 comprises a clip or other equipment which attaches to the equipment and cannot be released without manipulating the hook 101. One such example is where the hanging hook 101 comprises a mechanical clasp which clasps with the shield, for example. It will still function like the open-ended hanging hook 101 as pictured, but the shield will remain coupled with the support system 100 until the clasp is manipulated.

As noted, in whichever configuration, the hanging hook 101 couples to the equipment. The weight of the equipment, such as a shield, rests upon the hanging hook 101. This weight is transferred and distributed to the harness strap 103. The weight of the equipment is then distributed along the straps which connect to the operator's body. This allows for a better weight distribution than if the entirety of the shield is held by the operator's hands.

In one embodiment, and as depicted, the hanging hook 101 is oriented to the bottom of the support system. This allows the harness strap 103 to hang downward from the operator and support the weight of the comparatively lower hanging hook 101 and its coupled equipment.

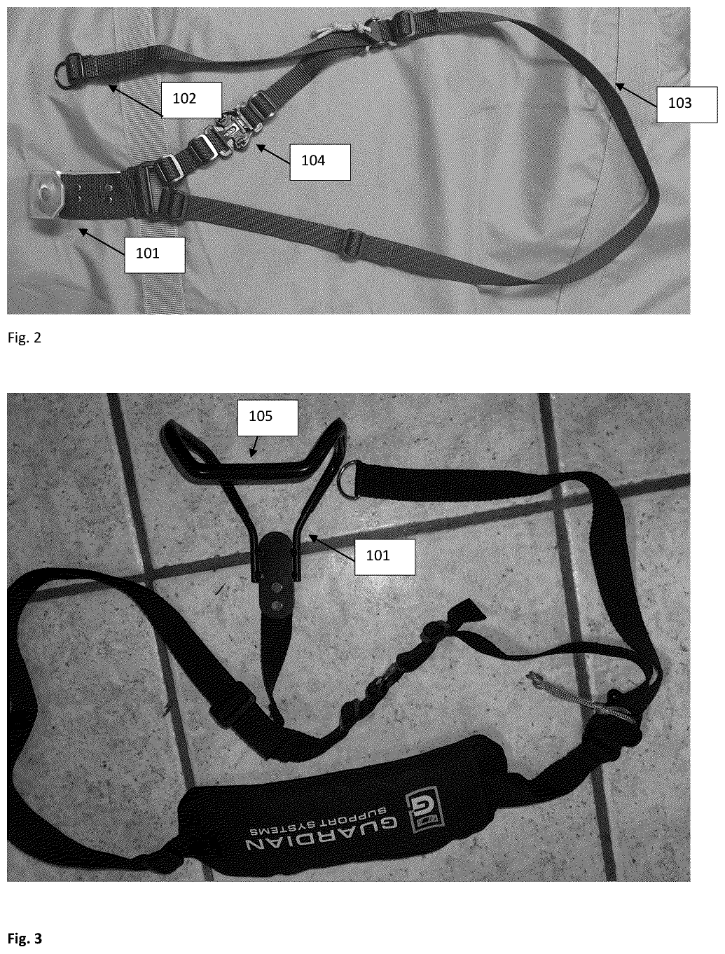

FIG. 2 is a top perspective view of a support system in one embodiment. In this view the open hanging hook 101 is not as visible, but the relationship between the adjusting strap 102 and the harness strap 103 is more clearly seen.

FIG. 3 is a top perspective view of a support system in one embodiment. In this embodiment the hanging hook 101 comprises bent and spaced-apart members rather than a solid hook as shown in FIGS. 1 and 2. The hook 101 is not contiguous like the hook in FIGS. 1 and 2. The hook 101 still comprises a lip 105 which arises above the planar surface of the bottom of the hook. As noted, this provides a location which can grip and hold the shield. In the embodiment depicted in FIG. 3, the hanging hook 101 is wider. This provides additional stability and control.

As depicted in FIG. 3, the hanging hook 101 comprises a discrete and wire member. This reduces the weight of the hook 101. As can be seen, the wire member (which could be rods, wires, bolts, etc.) is non-contiguous in that there is a gap between adjacent wires. In one embodiment the hook 101 comprises steel with a coating. The coating can comprise virtually any material including plastic, rubber, etc. Such materials simultaneously protect the hook 101 as well as offer increased grip and traction compared to a metallic hook. Increasing grip and traction helps ensure the shield, or other object, is maintained in its desired location. The shield, as an example, is less likely to move or slide when the hook 101 comprises an increased grip surface.

The width of the hanging hook 101 can vary depending upon the desired application. In one embodiment the width, as measured by the dimension which is parallel to the shield, and parallel to the ground, is between 4 and 5 inches. This provides sufficient with the shield to stability and support the shield.

The height of the hanging hook 101 as measured by the dimension which is perpendicular to the ground when in use, is about 4-6 inches, depending upon the application.

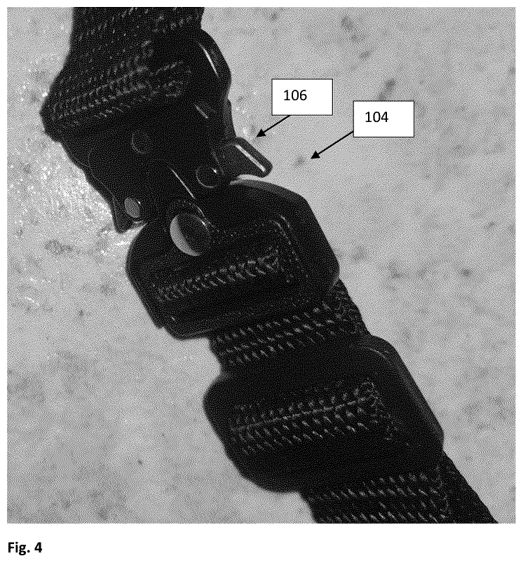

FIG. 4 is a top perspective view of a clip in one embodiment. FIG. 4 shows an example of one clip 104. This is for illustrative purposes only and should not be deemed limiting. Various other clips 104 which allow the mechanical coupling and de-coupling of two or more objects, such as straps, can be utilized. In the embodiment depicted, the clip 104 comprises a quick-release 106 which allows the clip 104 to be quickly de-coupled. This allows the user to quickly detach the clip 104 so as to remove and detach the harness strap 103. The ability to quickly detach the harness strap 103, if desired, is advantageous. It is helpful to the user to quickly disengage from the harness strap 103 and support system if needed. This increases the user's nimbleness.

As noted, there are significant advantages to the system and method discussed herein. First, the system allows the weight of the equipment, such as a ballistics shield, to be evenly distributed over the operator as opposed to concentrating the weight in the hands and arms of the operator. If the system is coupled to an operator's neck and shoulders, for example, the weight of the shield is carried by the operator's neck and shoulders as opposed to the hands and arms. The hands and arms can quickly tire whereas the operator can likely hold the shield via their shoulders for a comparatively much longer duration.

Second, in some embodiments, the system frees the operator's arms and hands to be directed toward the objective before the operator rather than holding and carrying the equipment. As noted, previously, the operator had to hold the shield with their off-hand and manipulate, aim, and fire the firearm with one hand. This system, in some embodiments, allows the operator to have both hands free and available. This allows for more accurate shooting, aiming, reloading, etc. which are more difficult tasks with one hand. This system accordingly increases the safety and effectiveness of the operator. As noted, in some embodiments the off-hand might still be necessary to stabilize the shield. That stabilization can be achieved with the user's off-hand, an elbow, a knee, etc. Even if the shield needs stabilization with the user's off-hand, the operator still has superior movement and freedom compared to the prior art systems whereby the off-hand was used to carry the weight and stabilize the shield.

While the invention has been particularly shown and described with reference to a preferred embodiment, it will be understood by those skilled in the art that various changes in form and detail may be made therein without departing from the spirit and scope of the invention.

What is claimed is:

1. A support system comprising:
an adjusting strap coupled to a harness strap;
wherein said harness strap is coupled to a hanging hook.

2. The support system of claim 1 wherein said harness strap further comprises a clip.

3. The support system of claim 1 wherein said clip comprises a quick release.

4. The system of claim 1 wherein said hanging hook comprises a lip.

5. The system of claim 1 wherein said hanging hook comprises an open end to receive equipment.

6. The system of claim 1 wherein said hanging hook comprises a planar body and a planar lip.

7. The system of claim 6 wherein said planar body is contiguous.

8. The system of claim 1 wherein said hanging hook is non-contiguous.

9. The system of claim 1 wherein said hanging hook comprises a non-contiguous wire.

10. The system of claim 1 further comprising a shield which couples to said hanging hook.

11. The system of claim 10 wherein said shield comprises a ballistics shield.

12. The system of claim 1 wherein said harness strap couples to a user.

13. The system of claim 12 further comprising a shield which couples to said hanging hook.

14. The system of claim 13 which allows a user a hands-free opportunity to hold said shield.
